(19) United States
(12) Patent Application Publication
(10) Pub. No.: US 2008/0274757 A1
(43) Pub. Date: Nov. 6, 2008

(54) System and Method for Enhanced Item Tracking

(75) Inventor: Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/743,787

(22) Filed: May 3, 2007

(51) Int. Cl. H04Q 7/20

(52) U.S. Cl. 455/466

(57) ABSTRACT

A service that leverages established wireless messaging paradigms such as, possibly inter alia, Short Message Service and Multimedia Message Service to allow Mobile Subscribers to use their Wireless Devices to comprehensively dynamically track items such as, possibly inter alia, RFID-augmented items, within multiple devices such as, possibly inter alia, next-generation or intelligent appliances (e.g., refrigerators), intelligent storage facilities (in, e.g., a home, a store, a restaurant, a hospital). The service may optionally leverage the capabilities of a Messaging Inter-Carrier Vendor.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS), Multimedia Message Service (MMS), IP Multimedia Subsystem (IMS), etc.

2. Background of the Invention

As the ‘wireless revolution’ continues to march forward the importance to a Mobile Subscriber (MS), for example a user of a Wireless Device (WD) such as a mobile telephone, BlackBerry, etc. that is serviced by a Wireless Carrier (WC), of their WD grows substantially while, simultaneously, the challenges that are associated with offering to MSs new and useful services, particularly within a truly ubiquitous cross-WC environment, similarly increase.

At the same time, technological advances such as passive and active Radio-Frequency Identification (RFID), Near-Field Communication (NFC), etc. have yielded small, inexpensive, etc. solutions that, as just one possible example, can support the ubiquitous ‘tagging’ of items—e.g., food items available at a grocery store, prescription and Over-the-Counter (OTC) medications, health care products, books, magazines, newspapers, audio Compact Discs (CDs), movie Digital Video Discs (DVDs), etc.—in support of, possibly inter alia, the tracking of the presence, status, condition, etc. of such items.

As the complexities of modern life continue to expand the need for individuals to dynamically track aspects of (for example, possibly inter alia, RFID-augmented) items—for example, possibly inter alia, the freshness of a particular food item in a person's refrigerator, the quantity of a particular item in a person's pantry, the quantity remaining of an individual's prescription or OTC medication, the quantity of various items in a commercial setting (such as a hospital, restaurant, store, etc.)-steadily increases.

The present invention extends key elements of wireless technology to allow MSs to use their WDs to more easily dynamically track items, and addresses various of the (not insubstantial) challenges that are associated with same.

### SUMMARY OF THE INVENTION

Embodiments of the present invention provide mechanisms through which a MS′ WD may be utilized to more easily dynamically track items.

In one embodiment a method for item tracking includes receiving from a device a notification message indicating a change in the presence, status, condition, etc. of an item; performing one or more processing steps on the notification message using, at least in part, information previously supplied by a MS; generating an alert message in view of the processed indication; and dispatching the alert message to a WD of said MS.

In an aspect of this and other embodiments said notification messages contain some combination of Electronic Product Code (EPC), Global Trade Item Number (GTIN), and Stock Keeping Unit (SKU).

In an aspect of this and other embodiments said information is defined by a MS during a registration process, and the information may include at least one of Identifying Information, Device Information, Item Information, Alert Information, and Billing Information. The information may further be preserved through a User Profile.

In another aspect of this and other embodiments the registration process is Web-based, and may include a billing component.

In a preferred implementation the alert message is a SMS message or a MMS message, and may contain advertising and/or promotional material.

In one possible implementation, a fee is charged for the tracking service.

The method of this and other embodiments may further include receiving a reply from said Mobile Subscriber; processing said reply resulting in a processed reply; and conditionally communicating with a third party in view of the processed reply.

These and other features of the embodiments of the present invention along with their attendant advantages will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV) in accordance with an embodiment of the invention.

FIG. 2 illustrates various of the exchanges or interactions that are supported by aspects of a registration process in accordance with an embodiment of the present invention.

FIG. 3 illustrates further of the exchanges or interactions that are supported by aspects of embodiments of the present invention.

FIG. 4 is a diagrammatic presentation of aspects of an exemplary Service Provider (SP) Application Server (AS) in accordance with an embodiment of the present invention.

### DETAILED DESCRIPTION

Embodiments of the present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same.

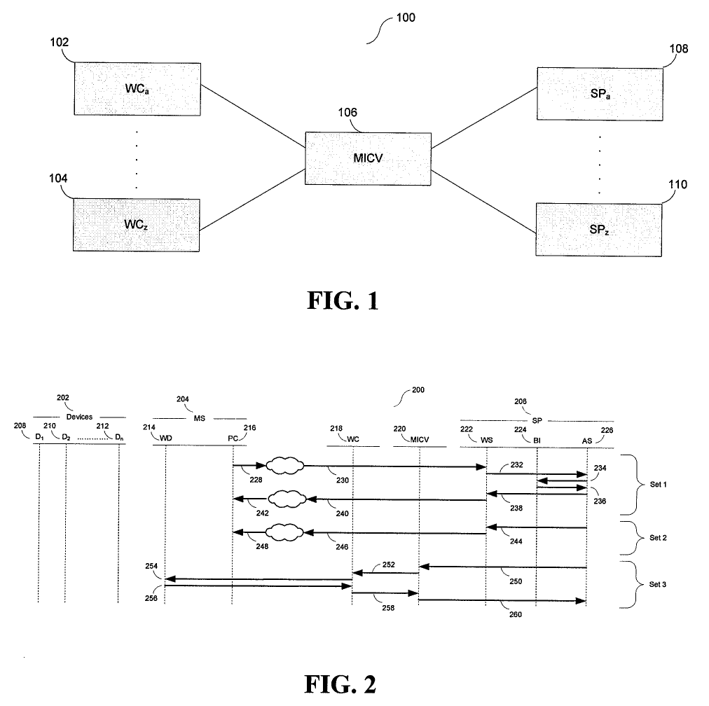

As depicted in FIG. 1 and shown generally by reference numeral 100, a MICV 106 may be disposed between, possibly inter alia, multiple WCs (WCₐ 102→WC_{z} 104) on one side and multiple SPS (SPₐ 108→SP_{z} 110) on the other side thus ‘bridging’ all of the connected entities. A MICV 106 thus, as one simple example, may offer various routing, formatting, delivery, value-add, etc. capabilities that provide, possibly inter alia:

1) A WC 102→104 (and, by extension, all of the MSs that are serviced by the WC 102→104) with ubiquitous access to a broad universe of SPs 108→110, and

2) A SP 108→110 with ubiquitous access to a broad universe of WCs 102→104 (and, by extension, to all of the MSs that are serviced by the WCs 102→104).

While the discussion below will include a MICV, it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SPₓ offers a service that has been enhanced or augmented as provided through aspects of the instant invention and Mary, a MS, uses SPₓ's service.

FIG. 2 and reference numeral 200 illustrate various of the exchanges or interactions that might occur under a portion of our hypothetical example. Of interest and note in the diagram are the following entities:

Devices 202 D₁ 208→Dₙ 212. For example, possibly inter alia, next-generation or intelligent appliances (such as refrigerators, etc.), intelligent storage facilities, etc. (which will be further described below).

MS 204 WD 214. For example, Mary's WD such as mobile telephone, BlackBerry, PalmPilot, etc.

MS 204 Personal Computer (PC) 216. For example, one of Mary's home, work, etc. PCs.

WC 218. The provider of service for Mary's WD 214.

MICV 220. As noted above the use of a MICV, although not required, provides significant advantages.

SP 206 Web Server (WS) 222. A publicly-available Web site that is optionally provided by SPX 206.

SP 206 Billing Interface (BI) 224. A single, consolidated interface that SPₓ 206 may use to easily reach, inter alia, one or more external entities such as a credit card or debit card clearinghouse, a carrier billing system, a service bureau that provides access to multiple carrier billing systems, etc.

SP 206 AS 226. Facilities that provide key elements of the instant invention (which will be described below).

It is important to note that while in FIG. 2 the MS 204 WD 214 and MS 204 PC 216 entities are illustrated as being adjacent or otherwise near each other, in actual practice the entities may, for example, be physically located anywhere.

The devices 202 that are illustrated in FIG. 2, D₁ 208→Dₙ 212, may offer, possibly inter alia, an RFID reader, scanner, inspector, etc. capability that among other things can monitor for example the addition of and/or the removal of a (for example, possibly inter alia, RFID-augmented) item and communicate directly or indirectly aspects of same to, possibly inter alia, a SP 206. Examples of such devices might include, possibly inter alia, next-generation or intelligent appliances (such as refrigerators, etc.), intelligent storage facilities (in a home, in a store, at a restaurant, in a hospital, etc.), augmented book stacks in a library, etc.

In FIG. 2 the exchanges that are collected under the designation Set 1 represent the activities that might take place as Mary 204 completes a registration process with SPₓ 206:

A) Mary 204 uses one of her PCs 216 to visit SPₓ's 206 WS 222 to, possibly among other things, complete a service registration process (228→230).

B) SPₓ's 206 WS 222 interacts with SPₓ's 206 AS 226 to, possibly among other things, commit some or all of the information that Mary 204 provided to a data repository (e.g., a database), optionally complete a billing transaction, etc. (232).

C) As appropriate and as required BI 224 completes a billing transaction (234→236).

D) SPₓ's 206 WS 222 responds appropriately (e.g., with the presentation of a confirmation message, etc.) (240→242).

The specific exchanges that were described above (as residing under the designation Set 1) are illustrative only and it will be readily apparent to one of ordinary skill in the relevant art that numerous other exchanges are easily possible and indeed are fully within the scope of the present invention. As just one example, the registration process may be completed through any combination of one or more channels including, inter alia, the World Wide Web (WWW via, for example, a Web site that is operated by SPₓ), wireless messaging (SMS, MMS, etc.), Electronic Mail (E-Mail) messages, Instant Messaging (IM), conventional mail, telephone, Interactive Voice Response (IVR) facility, etc.

During the registration process described above a range of information may be captured from a MS including, inter alia:

A) Identifying Information. For example, possibly among other things, name, address, landline and wireless Telephone Numbers (TNs), E-Mail addresses, IM names/identifiers, a unique identifier and a password, etc.

B) Device Information. For example, information on devices that are to be monitored/supported including, possibly among other things, name, characteristics, location, contact or connection details, access credentials (such as, possibly inter alia, user identifier and password), etc.

C) Item Information. For example, information on items that customarily reside in a device including, possibly among other things, name, characteristics, image or picture, quantity thresholds (e.g., maximum, customary, minimum), anticipated consumption, anticipated turnover rate, one or more identifiers (such as, for example, EPC, GTIN, SKU, etc.), source(s) or vendor(s), etc.

D) Alert Information. For example, triggers, thresholds, etc. that may be based on, possibly among other things, item quantity, date, etc.—e.g., the minimum allowed quantity of item A is X, item B must be discarded after Y days, Z amount of item C should always be available, etc.

E) Billing Information. Different service billing models may be offered including, inter alia, a fixed one-time charge, a recurring (monthly, etc.) fixed charge, a recurring (monthly, etc.) variable charge, etc. Different payment mechanisms may be supported including, possibly among other things, credit or debit card information, authorization to place a charge on a MS's phone bill, etc.

The specific pieces of information that were described above are illustrative only and it will be readily apparent to one of ordinary skill in the relevant art that numerous other pieces of information (e.g., additional Subject Information, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database) and may optionally be organized as a MS Profile.

The content of Mary's profile may be augmented by SPX to include, as just a few examples of the many possibilities, internal and/or external demographic, psychographic, sociological, etc. data.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

In FIG. 2 the exchanges that are collected under the designation Set 2 represent the activities that might take place as SPₓ's 206 AS 226 dispatches to Mary 204 one or more, e.g., confirmation E-Mail messages (244→248).

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 2 the exchanges that are collected under the designation Set 3 represent the activities that might take place as SPₓ's 206 AS 226 dispatches one or more confirmation SMS, MMS, etc. messages to Mary's 204 WD 214 (250→254) and Mary 204 optionally replies or responds to the message(s) (256→260).

In the instant example the messages are shown traversing a MICV 220.

The SP 206 may employ a Short Code (SC) or a regular TN as its source address (and to which it would ask users of its service to direct any reply messages). While the abbreviated length of a SC (e.g., five digits for a SC administered by Neustar under the Common Short Code [CSC] program) incrementally enhances the experience of a MS 204 (e.g., the MS 204 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

The specific exchanges that were described above (as residing under the designation Set 3) are illustrative only and it will be readily apparent to one of ordinary skill in the relevant art that numerous other exchanges are easily possible and indeed are fully within the scope of the present invention.

The Set 1, Set 2, and Set 3 exchanges that were described above are illustrative only and it will be readily apparent to one of ordinary skill in the relevant art that numerous other exchanges are easily possible and indeed are fully within the scope of the present invention. For example, possibly inter alia:

1) Mary or MS 204 may need to complete one or more configuration, etc. activities on each of the identified devices 202 (D₁ 208→Dₙ 212) to, for example, identify to a device 202 the particulars (including, possibly inter alia, communication paradigm, address, access credentials, etc.) of a SP's 206 AS 226.

2) A SP 206 may optionally dispatch one or more test messages to a device 202 (D₁ 208→Dₙ 212) and a device may optionally respond. Such messages may traverse any combination of a range of communication channels including, possibly inter alia, the open Internet, a Virtual Private Network (VPN) over the open Internet, a dedicated link, a wireless (WiFi, etc.) link, a SMS/MMS/etc. messaging facility, etc.

To continue with our hypothetical example . . . as time passes, items (for example, possibly inter alia, RFID-augmented items) may be placed within, added to, etc. and/or removed from one or more devices (i.e., devices such as intelligent appliances, intelligent storage facilities, etc. as described above). For example, possibly inter alia:

1) An individual may place items that she purchased at a grocery store in a refrigerator and/or remove such items from the refrigerator.

2) An individual may place items that she purchased at a grocery store in a pantry and/or remove such items from the pantry.

3) Staff at a hospital may place supplies, medications, etc. in a storage facility and/or remove such items from the storage facility.

4) Customers, staff, etc. at a library may remove a book from a shelf or a stack and/or place a book on a shelf or a stack.

5) Customers, staff, etc. in a store may remove a book, magazine, CD, DVD, etc. from a shelf or rack and/or place a book, magazine, CD, DVD, etc. on a shelf or rack.

6) An individual may place her prescription or OTC medications in a cabinet and/or remove such items from the cabinet.

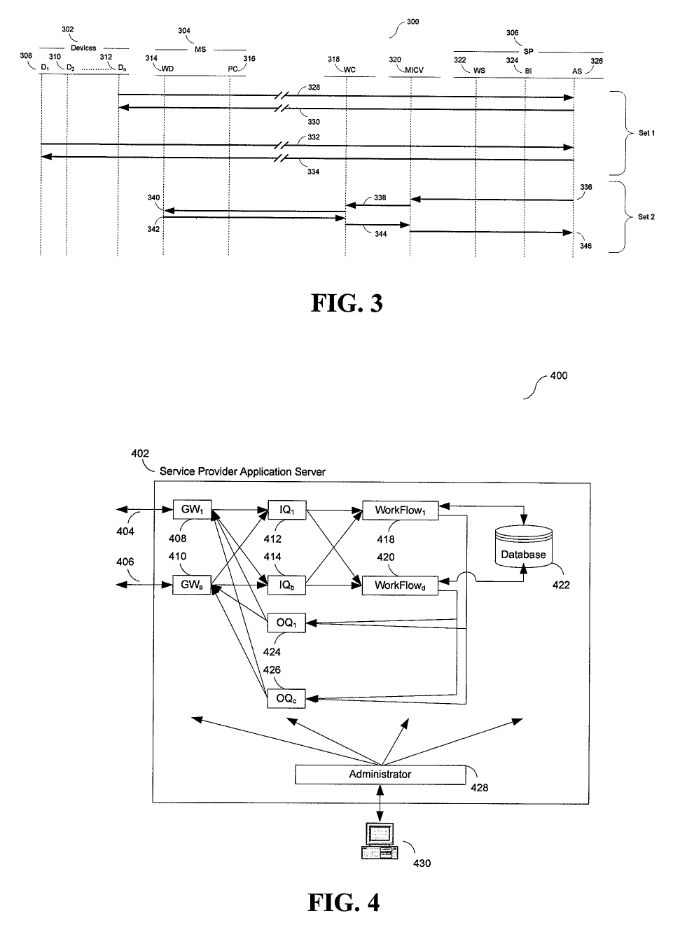

FIG. 3 and reference numeral 300 illustrates various of the exchanges or interactions that might occur under this aspect of our hypothetical example. The entities that are depicted in FIG. 3 are the same as were depicted in, and described for, FIG. 2.

In FIG. 3 the exchanges that are collected under the designation Set 1 represent the activities that might take place as:

1) A device 302 (D₁ 308→Dₙ312) detects the addition of an item and/or the removal of an item and, possibly inter alia, communicates same to a SP's 306 AS 326 via one or more notification messages—e.g., 328 for device 302 Dₙ 312 and 332 for device 302 D₁ 308.

2) A SP's 306 AS 326 optionally responds with one or more reply messages—e.g., 330 to device 302 Dₙ 312 and 334 to device 302 D₁ 308.

A notification message may contain, possibly inter alia, the particulars of a device 302 (such as, for example, address, etc.), the particulars of the instant item (such as, for example, an EPC or other ‘tag’ value, etc.), a date/time stamp, etc. and may be communicated through any combination of a range of channels including, possibly inter alia, the open Internet, a VPN over the open Internet, a dedicated link, a wireless (WiFi, etc.) link, a SMS/MMS/etc. messaging facility, etc.

A reply message may contain, possibly inter alia, a status code or identifier, a date/time stamp, etc.

The specific exchanges that were described above (as residing under the designation Set 1) are illustrative only and it will be readily apparent to one of ordinary skill in the relevant art that numerous other exchanges are easily possible and indeed are fully within the scope of the present invention.

In FIG. 3 the exchanges that are collected under the designation Set 2 represent the activities that might take place as a SP's 306 AS 326 completes one or more processing steps, leveraging among other things various of the information that was supplied previously during a registration process, and dispatches one or more SMS, MMS, etc. alert messages to Mary's 304 WD 314 (336→340) and Mary 304 optionally replies or responds to the message(s) (342→346). In the instant example the messages are shown traversing a MICV 320.

The processing steps mentioned above may include, possibly inter alia, determining from the address of a device the identity of a subscriber (e.g., a MS), within a repository updating for a subscriber's (e.g., a MS′) device an item's status (e.g., date/time last accessed, depletion indicator [e.g., an item was removed and not replaced], etc.), passing elements of a subscriber's (e.g., a MS′) registration information (including, for example, Device Information, Item Information, Alert Information) against the subscriber's device and item status information to generate an appropriate set of alert messages, etc.

An alert message may contain, possibly inter alia, a textual description (e.g., “Device X is out of Item Y”, “Device X is low on Item Y”, “Item Y in Device X has reached its expiration date”, etc.), a graphical element (e.g., a picture of an item, etc.), a status code or identifier, a date/time stamp, etc.

The Set 1 and Set 2 exchanges that were described above are illustrative only and it will be readily apparent to one of ordinary skill in the relevant art that numerous other exchanges are easily possible and indeed are fully within the scope of the present invention. For example, possibly inter alia, a SP may offer any number of enhancements to the basic service, some or all of which may have an associated additional (incremental) fee or charge:

1) Mary may identify as one of her devices the refrigerator of an elderly relative and, for that device, identify the normal or customary contents. Subsequently Mary may receive alerts when, for example, an item has been in the refrigerator longer than it should, the date of last use of an item has exceeded its acceptable limit, an item is depleted or gone, etc. Mary may use the received alerts to purchase the necessary items when she is next at the grocery store.

2) Mary may request that a SP automatically submit the particulars of items in an alert message to, possibly inter alia, an on-line grocery service (such as Peapod). Alternatively Mary request that a SP pass to her the particulars of such items so that she may, possibly inter alia, review and/or approve such a submission. Mary may optionally request to receive SMS/MMS/etc. confirmation message(s) of such submissions.

3) During registration Mary may identify recipes and the list of ingredients for a recipe. Subsequently Mary may add to her recipe list (e.g., Mary may see a new recipe on the Internet, in a magazine, etc.).

4) Mary may submit a recipe to a SP (e.g., from her WD, over the WWW, etc.) and subsequently receive from the SP an update (in the form of, possibly inter alia, one or more SMS/MMS/etc. messages) indicating what ingredients Mary does not have, does not have enough of, etc. As described in #2 above, Mary may optionally request that a SP submit the particulars of the indicated items to, possibly inter alia, an on-line grocery service (such as Peapod).

4) A SP may monitor the usage or consumption of items in a device and, based for example on past or historical usage patterns, predict when a quantity of an item might reach zero/empty or some other trigger threshold, and dispatch an appropriate set of alert messages.

5) Mary may submit an ‘update’ request (e.g., from WD, over the WWW, etc.) and subsequently receive back a response containing a list of the current contents of one or more device(s).

6) A SP may allow elements of its tracking facility to be coupled, etc. to an inventory management system, check out system, etc. For example, a library might tie or couple its check out system to a SP's tracking facility for more comprehensive tracking of books, etc. in the library (e.g., if an item is not on a shelf and it is not indicated as being checked out then it may be misplaced, lost, stolen, etc.).

7) Mary may request that a SP send alert messages to multiple targets—e.g., a SMS/MMS/etc. message to one or more WDs, a message to one or more E-Mail addresses, a message to one or more IM addresses, etc.

Alert messages may be timed to reach MS 204 at predetermined times (e.g., near the end of a work day) or at pre-determined locations (e.g., as MS 204 approaches a grocery store on the way home from work). In the latter case, AS 326 preferably receives location information from, e.g., WC 318, and determines when to send the alert message(s). The timing of the alert messages may also be based on the nature of the item itself. For instance, if the item is typically bought in a grocery store, and replenishment is not an emergency, then an after work message might be appropriate. On the other hand, if an urgent medication is depleted, then the alert message is preferably sent immediately.

The enhancements that were described above are illustrative only and it will be readily apparent to one of ordinary skill in the relevant art that numerous other exchanges are easily possible and indeed are fully within the scope of the present invention.

The confirmation, alert, response, etc. message(s) that were described above may optionally contain an informational element—e.g., a relevant or applicable factoid about a specific drug, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location-Based Services [LBS] facility).

The confirmation, alert, response, etc. message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The confirmation, alert, response, etc. message(s) may optionally contain promotional materials (e.g., still images, video clips, etc.).

FIG. 4 provides a diagrammatic presentation of aspects of an exemplary SP AS 402. The illustrated AS 402 contains several key components—Gateways (GW₁ 408→GWₐ 410 in the diagram), Incoming Queues (IQ₁ 412→IQ_{b} 414 in the diagram), WorkFlows (WorkFlow₁ 418→WorkFlow_{d} 420 in the diagram), Database 422, Outgoing Queues (OQ₁ 424→OQ_{c} 426 in the diagram), and an Administrator 428. It will be readily apparent to one of ordinary skill in the relevant art that numerous other components are possible within an AS 402.

A dynamically updateable set of one or more Gateways (GW₁ 408→GWₐ 410 in the diagram) handle incoming (SMS/MMS/etc. messaging, SD, etc.) traffic and outgoing (SMS/MMS/etc. messaging, SD, etc.) traffic. Incoming traffic is accepted and deposited on an intermediate or temporary Incoming Queue (IQ₁ 412→IQ_{b} 414 in the diagram) for subsequent processing. Processed artifacts are removed from an intermediate or temporary Outgoing Queue (OQ₁ 424→OQ_{c} 426 in the diagram) and then dispatched.

A dynamically updateable set of one or more Incoming Queues (IQ₁ 412→IQ_{b} 414 in the diagram) and a dynamically updateable set of one or more Outgoing Queues (OQ₁ 424→OQ_{c} 426 in the diagram) operate as intermediate or temporary buffers for incoming and outgoing traffic.

A dynamically updateable set of one or more WorkFlows (WorkFlow₁ 418→WorkFlow_{d} 420 in the diagram) remove incoming traffic from an intermediate or temporary Incoming Queue (IQ₁ 412→IQ_{b} 414 in the diagram), perform all of the required processing operations, and deposit processed artifacts on an intermediate or temporary Outgoing Queue (OQ₁ 424→OQ_{c} 426 in the diagram). The WorkFlow component will be described more fully below.

The Database 422 that is depicted in FIG. 4 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 428 that is depicted in FIG. 4 provides management or administrative control over all of the different components of an AS 402 through, as one example, a Web-based interface 430. It will be readily apparent to one of ordinary skill in the relevant art that numerous other interfaces (e.g., a data feed, etc.) are easily possible.

Through flexible, extensible, and dynamically updatable configuration information a WorkFlow component may be quickly and easily realized to support any number of activities. For example, WorkFlows might be configured to support a registration process; to support interactions with devices; to support various internal processing steps including, possibly inter alia, the generation and dispatch of confirmation, alert, response, etc. messages; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support scheduled (e.g., daily, weekly, etc.) and/or on-demand reporting with report results delivered (to, for example, a MS) through SMS, MMS, etc. messages; through E-Mail; through a Web-based facility; etc.

It is important to note that while aspects of the discussion that was presented above focused on the use of RFID elements it will be readily apparent to one of ordinary skill in the relevant art that other entities (such as, possibly inter alia, GTINs [such as for example Universal Product Codes {UPCs}, European Article Numbers {EANs}, and/or Japanese Article Numbers {JANs}), SKUs, etc.) are equally applicable and, indeed, are fully within the scope of the present invention. As well, devices that may be augmented by entity (UPC, SKU, etc.) specific detection paradigms (such as, for example, scanners, readers, inspectors, acquirers, etc.) are also equally applicable and, indeed, are fully within the scope of the present invention.

It is important to note that while aspects of the discussion that was presented above focused on the use of SCs it will be readily apparent to one of ordinary skill in the relevant art that TNs and other message address identifiers are equally applicable and, indeed, are fully within the scope of the present invention.

The discussion that was just presented referenced two specific wireless messaging paradigms—SMS and MMS. These paradigms potentially offer an incremental advantage over other paradigms in that native support for SMS and/or MMS is commonly found on a WD that a potential MS would be carrying. However, it is to be understood that it would be readily apparent to one of ordinary skill in the relevant art that other paradigms (such as, for example, IMS, IM, E-Mail, etc.) are fully within the scope of the present invention.

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| AS | Application Server |
| BI | Billing Interface |
| CD | Compact Disc |
| CSC | Common Short Code |
| DBMS | Database Management System |
| DVD | Digital Video Disc |
| EAN | European Article Number |
| E-Mail | Electronic Mail |
| EPC | Electronic Product Code |
| GTIN | Global Trade Item Number |
| GW | Gateway |
| IM | Instant Messaging |
| IMS | IP Multimedia Subsystem |
| IQ | Incoming Queue |
| IVR | Interactive Voice Response |
| JAN | Japanese Article Number |
| LBS | Location Based Services |
| MICV | Messaging Inter-Carrier Vendor |
| MMS | Multimedia Message Service |
| MS | Mobile Subscriber |
| NFC | Near Field Communication |
| ODBMS | Object Database Management System |
| OQ | Outgoing Queue |
| OTC | Over-the-Counter |
| PC | Personal Computer |
| RDBMS | Relational Database Management System |
| RFID | Radio Frequency Identification |
| SC | Short Code |
| SKU | Stock Keeping Unit |
| SMS | Short Message Service |
| SP | Service Provider |
| TN | Telephone Number |
| UPC | Universal Product Code |
| VPN | Virtual Private Network |
| WC | Wireless Carrier |
| WD | Wireless Device |
| WS | Web Server |
| WWW | World-Wide Web |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the relevant art in light of the above disclosure.

What is claimed is:

1. A method for item tracking, comprising:
receiving from a storage device a notification message indicating a change in the presence of an item that is stored in or in the vicinity of said storage device;
processing said notification message based, at least in part, on information previously supplied by a Mobile Subscriber who has an interest in a status of the item;
generating an alert message including an indication of the status of the item; and
dispatching said alert message to a Wireless Device of said Mobile Subscriber.

2. The method of claim 1, wherein said storage device contains a reader/scanner facility.

3. The method of claim 2, wherein said reader/scanner facility is responsive to at least one of RFID, a UPC, and a SKU.

4. The method of claim 1, wherein said notification message contains at least one of an Electronic Product Code, Global Trade Item Number, and Stock Keeping Unit.

5. The method of claim 1, wherein said information is defined by a Mobile Subscriber during a registration process.

6. The method of claim 5, wherein said information includes at least one of Identifying Information, Device Information, Item Information, Alert Information, and Billing Information.

7. The method of claim 5, wherein said information is preserved through a User Profile.

8. The method of claim 5, wherein said registration process is Web-based.

9. The method of claim 5, wherein said registration process includes a billing component.

10. The method of claim 1, wherein said alert message is a SMS message.

11. The method of claim 1, wherein said alert message is a MMS message.

12. The method of claim 1, wherein said alert message contains advertising and/or promotional material.

13. The method of claim 1, further comprising:
charging a fee for said item tracking.

14. The method of claim 1, further comprising:
receiving a reply from said Mobile Subscriber;
processing said reply resulting in a processed reply; and
conditionally communicating with a third party in view of the processed reply.

15. The method of claim 14, wherein said third party is an online grocery service.

16. The method of claim 1, wherein said storage device is a refrigerator.

17. The method of claim 1, wherein said storage device is a book stack.

18. The method of claim 1, wherein said storage device is storage facility.

19. The method of claim 1, wherein the item is RFID-augmented.

20. The method of claim 1, wherein the item belongs to someone other than the Mobile Subscriber.

21. The method of claim 1, further comprising dispatching said alert message at a predetermined time based on a nature of the item.

22. An item tracking method, comprising:
receiving a notification message, initiated by a storage device, that indicates a depletion of a given item;
identifying, based on the storage device, a Mobile Subscriber who has previously, through a registration process, associated the storage device with a mobile telephone telephone number of the Mobile Subscriber;
generating an alert message that includes the telephone number as part of addressing information for the alert message; and
dispatching the alert message to the Mobile Subscriber, and thereby indicating to the mobile Subscriber that the item has been depleted.

23. The method of claim 22, wherein the storage device is a refrigerator.

24. The method of claim 22, wherein in the storage device is storage facility.

25. The method of claim 22, wherein a timing of the step of dispatching the alert message is based on a nature of the item.

26. The method of claim 22, wherein a timing of the step of dispatching the alert message is based on the location of the Mobile Subscriber.

27. The method of claim 22, further comprising receiving a response message from the Mobile Subscriber in response to the alert message, the response message indicating a desire to place the item on a list for replenishment.

28. The method of claim 27, wherein the item is a grocery item.

29. The method of claim 27, wherein the list is associated with an on-line shopping system.

30. The method of claim 22, wherein the storage device detects RFID information associated with the item.

31. The method of claim 22, wherein the item belongs to someone other than the Mobile Subscriber.
